(19) United States
(12) Patent Application Publication
(10) Pub. No.: US 2018/0114647 A1
(43) Pub. Date: Apr. 26, 2018

(54) CAPACITOR AND METHOD FOR MANUFACTURING THE CAPACITOR

(71) Applicant: Murata Manufacturing Co., Ltd., Nagaokakyo-shi (JP)

(72) Inventors: Noriyuki Inoue, Nagaokakyo-shi (JP); Kazuo Hattori, Nagaokakyo-shi (JP); Hiromasa Saeki, Nagaokakyo-shi (JP)

(21) Appl. No.: 15/849,850

(22) Filed: Dec. 21, 2017

Related U.S. Application Data
(63) Continuation of application No. PCT/JP2016/072193, filed on Jul. 28, 2016.

(30) Foreign Application Priority Data
Aug. 7, 2015 (JP) 2015-157353

(51) Int. Cl. H01G 4/33; H01G 4/248; H01G 4/08

(52) U.S. Cl. CPC H01G 4/33; H01G 4/08; H01G 4/248

(57) ABSTRACT

A capacitor having an element main body including a metal high specific surface area substrate which has fine pores formed therein and a large specific surface area; a dielectric layer formed in a prescribed region on the surface of the high specific surface area substrate including the inner surfaces of the pores; and a conductive part on the dielectric layer. A first terminal electrode is electrically connected to the high specific surface area substrate. A second terminal electrode is electrically connected to the conductive part. The dielectric layer is interposed between the conductive part and the high specific surface area substrate, and the high specific surface area substrate and the second terminal electrode are electrically insulated from each other.

### CROSS REFERENCE TO RELATED APPLICATIONS

The present application is a continuation of International application No. PCT/JP2016/072193, filed Jul. 28, 2016, which claims priority to Japanese Patent Application No. 2015-157353, filed Aug. 7, 2015, the entire contents of each of which are incorporated herein by reference.

### FIELD OF THE INVENTION

The present invention relates to a capacitor and a method for manufacturing the capacitor.

### BACKGROUND OF THE INVENTION

Nowadays, many and various capacitors are installed in electronic devices such as personal computers and handheld terminals. Among this type of capacitors, a solid electrolytic capacitor can make a dielectric layer thinner since an oxide film formed by anodizing is used as a dielectric layer, and therefore the solid electrolytic capacitor is widely used as a capacitor which can be miniaturized and whose capacity can be increased.

For example, Patent Document 1 proposes a solid electrolytic capacitor including an anode containing a valve action metal or an alloy thereof, a dielectric layer disposed on the surface of the anode, a cathode disposed on the surface of the dielectric layer, and an outer body resin covering the anode, the dielectric layer and the cathode, wherein a glass transition temperature of the outer body resin ranges from 0.50 times to 0.90 times as high as a maximum glass transition temperature.

In Patent Document 1, the anode is formed of a porous sintered body predominantly composed of a valve metal such as Nb, the porous sintered body is subjected to anodizing to form a dielectric layer made of an oxide film, an electrolyte layer formed of a conductive polymer such as polypyrrole is disposed on the dielectric layer to form a cathode of the electrolyte layer. Then, Patent Document 1 proposes obtaining a solid electrolytic capacitor in which a leakage current is small and a reduction of the capacitance in high-temperature storage is suppressed by setting the glass transition temperature of the outer body resin to the above-mentioned range.

Patent Document 2 proposes a solid electrolytic capacitor including an anode body composed of a sintered body, a dielectric film (dielectric layer) formed on the anode body, a cathode part formed on the dielectric film, and an anode lead projecting from the inside of the anode body to the outside, wherein the anode body includes a base part and a coarse particle part in which an average particle size of particles constituting the sintered body is larger than the base part, and a volume of the base part is larger than a volume of the coarse particle part.

As is nearly the case with Patent Document 1, in Patent Document 2, an anode is also formed of a sintered body of a valve action metal, such as Ta, Nb, Ti, or Al, the anode is subjected to anodizing to form a dielectric layer made of an oxide film, and a cathode is formed of a solid electrolyte such as a conductive organic material or a conductive inorganic material on the dielectric layer. Then, Patent Document 2 proposes suppressing equivalent series resistance (hereinafter, referred to as “ESR”) and equivalent series inductance (hereinafter, referred to as “ESL”) by controlling an average particle size of particles constituting the sintered body of a valve action metal or the like to thereby obtain a solid electrolytic capacitor capable of being downsized.

Patent Document 1: Japanese Patent Application Laid-Open No. 2009-54906 (claim 1, paragraphs [0020], [0029] to [0038])

Patent Document 2: Japanese Patent Application Laid-Open No. 2010-171256 (claim 1, paragraphs [0012], [0015], [0016], and the like)

### SUMMARY OF THE INVENTION

In each of solid electrolytic capacitors proposed in Patent Documents 1 and 2, since the dielectric layer is formed by anodizing, a dielectric layer of a thin film can be obtained, but the layer has many defects and insufficient insulating properties, and therefore the capacitor has a low dielectric breakdown voltage and reliability of the capacitor is low. Further, since the cathode is formed of an electrolyte, resistance is large, and therefore it is difficult to obtain a desired low ESR. Moreover, since the dielectric layer is formed by anodizing, a polarity is imparted to the solid electrolytic capacitor, and usability is to deteriorate.

The present invention has been made in view of such a situation, and it is an object of the present invention to provide a new type of capacitor and a method for manufacturing the capacitor, the capacitor being small, high capacity, and highly reliable and having low resistance and good insulating properties.

The present inventors used a metal high specific surface area substrate which has fine pores formed therein and has a large specific surface area, formed a dielectric layer and a conductive part on and above the high specific surface area substrate to prepare a capacitor structure, and made earnest investigations of the capacitor. As a result of this, it was found that it is possible to attain a capacitor which is small and high capacity, and has low resistance, good insulating properties and good reliability to obtain a new type of capacitor to replace conventional capacitors such as a solid electrolytic capacitor.

That is, a capacitor according to the present invention is a capacitor in which at least two terminal electrodes electrically insulated from each other are formed on the surface of an element main body, wherein the element main body has a high specific surface area substrate made of an electrical conductive material which has fine pores formed therein and has a large specific surface area; a dielectric layer is formed in a prescribed region of the surface of the high specific surface area substrate including the inner surfaces of the pores; and a conductive part formed on the dielectric layer. One terminal electrode of the two terminal electrodes is electrically connected to the high specific surface area substrate and the other terminal electrode is electrically connected to the conductive part. The dielectric layer is interposed between the conductive part and the high specific surface area substrate, and the high specific surface area substrate and the other terminal electrode are electrically insulated from each other.

In the capacitor of the present invention, the dielectric layer is preferably formed by being deposited in increments of an atomic layer.

Thereby, a dense dielectric layer can be attained, and it is possible to inhibit a defect from being produced, resulting in a reduction of insulating properties in contrast to the anodizing in a solid electrolytic capacitor, and to obtain a capacitor having high insulating properties.

Further, in the capacitor of the present invention, the conductive part is preferably filled in the inside of the pores.

Furthermore, in the capacitor of the present invention, the conductive part is also preferably formed along the dielectric layer inside the pores.

In any of the case where the conductive part is formed by being filled in the inside of the pores and the case where the conductive part is formed along the dielectric layer inside the pores, a new type of capacitor which is small and high capacity, and is not in a conventional capacitor can be obtained since a capacitance is acquired by utilizing many pores.

In the capacitor of the present invention, the electrical conductive material is preferably a metal material.

In the capacitor of the present invention, the conductive part is preferably formed of any one of a metal material and a conductive compound, and the conductive compound preferably contains a metal nitride or a metal oxynitride.

When the conductive part is formed of a metal material with low resistance, the ESR can be further reduced, and when the conductive part is formed of a conductive compound such as a metal nitride or a metal oxynitride, a conductive part having good uniformity can be formed up to the inside of the pores.

In the capacitor of the present invention, variation of the film thickness of the dielectric layer is preferably 10% or less on an absolute value basis with reference to an average film thickness thereof.

Thereby, it becomes possible to attain a conductive part in which the uniformity of a film thickness is high throughout the whole region where the conductive part is formed.

In the capacitor of the present invention, the element main body preferably has at least side surface parts covered with a protective layer made of an insulating material.

Thereby, it becomes possible to secure mechanical strength through the protective layer even when the high specific surface area substrate allegedly inferior in strength is used as a constituent of the element main body.

Also, in the capacitor of the present invention, it is preferred that a metal film is interposed between the protective layer and the conductive part.

As described above, by interposing the metal film, resistance can be further reduced and ESR can be further reduced.

In the capacitor of the present invention, the one terminal electrode and the other terminal electrode are preferably formed at both ends of the element main body so as to be opposed to each other.

In the capacitor of the present invention, preferably, the element main body has a plurality of regions including a first region that contributes to the acquisition of the capacitance and a second region having a smaller void ratio than the first region, and the second region is formed at at least both ends of the element main body.

Therefore, mechanical strength is secured by the second region, deformation and the like of the element main body can be avoided to the utmost. Then, it becomes possible to attain a capacitor having a desired capacitance while securing mechanical strength by adjusting a ratio between the first region and the second region.

Further, by a so-called multi-piece method, the above-mentioned capacitor can prepare many capacitors from a large and aggregate substrate, can be manufactured with efficiency, and can ensure good productivity.

That is, a method for manufacturing a capacitor according to the present invention includes an aggregate substrate preparation step of preparing an aggregate substrate made of an electrical conductive material which has fine pores formed therein and a large specific surface area; a dielectric layer formation step of forming a dielectric layer in a prescribed region of the surface of the aggregate substrate including the inner surfaces of the pores; a conductive part formation step of forming a conductive part on the surface of the aggregate substrate so as to meet the dielectric layer; a segmenting step of separating the aggregate substrate into segments to obtain an element main body including the high specific surface area substrate; and a terminal electrode formation step of forming one terminal electrode so as to be electrically connected to the element main body, and forming the other terminal electrode so as to be electrically insulated from the element main body.

The method for manufacturing a capacitor of the present invention preferably includes a comparting step of comparting the aggregate substrate into a plurality of regions, and the plurality of regions preferably includes a first region that contributes to the acquisition of the capacitance and a second region having a smaller void ratio than the first region.

This enables to obtain a capacitor in which the mechanical strength is improved and the capacitance can be easily adjusted.

With respect to the method for manufacturing a capacitor of the present invention, in the comparting step, the second region is preferably produced by causing the destruction of a part of the pores of the aggregate substrate, and this step preferably includes pressing or laser irradiation treatment for this purpose.

Further, with respect to the method for manufacturing a capacitor of the present invention, in the segmenting step, it is preferred to cut the aggregate substrate with use of any one of laser irradiation and a cutting tool.

In the method for manufacturing a capacitor of the present invention, the dielectric layer formation step preferably forms the dielectric layer by an atomic layer deposition method.

Thereby, it becomes possible to form, with high efficiency, a dielectric layer in which the uniformity of a film thickness is high up to a deep inside of the pores.

Further, in the method for manufacturing a capacitor of the present invention, the conductive part formation step preferably forms the conductive part by an atomic layer deposition method.

Thereby, it becomes possible to form the conductive part as a film with high efficiency in a state in which the conductive part meets the dielectric layer up to a deep inside of the pores.

According to the capacitor of the present invention, it is possible to obtain a capacitor which is small and high capacity, and has low resistance, good insulating properties and good reliability.

According to the method for manufacturing a capacitor of the present invention, since it includes the aggregate substrate preparation step, the dielectric layer formation step, the conductive part formation step, the segmenting step, and the terminal electrode formation step, respectively described above, it is possible to obtain, with high efficiency, capacitors from a large and aggregate substrate by a so-called multi-piece method to ensure high productivity, the capacitor being small, having a high capacity and having low resistance, good insulating properties and good reliability.

### BRIEF EXPLANATION OF THE DRAWINGS

FIG. 1 is a schematic cross-sectional view of an embodiment of a capacitor according to the present invention.

FIG. 2 is a sectional view viewed from the arrow direction of the X-X line of FIG. 1.

FIG. 3 is a greatly enlarged detailed sectional view of an A part of FIG. 1.

FIG. 4 is a greatly enlarged detailed sectional view of a B part of FIG. 1.

FIG. 5 is a greatly enlarged detailed sectional view of a C part of FIG. 1.

FIGS. 6(a) to 6(c) are manufacturing process views schematically showing a method for manufacturing a capacitor according to the present invention.

FIGS. 7(d₁) to 7(d₂) are manufacturing process views schematically showing a method for manufacturing a capacitor according to the present invention.

FIG. 8(e) is a manufacturing process view schematically showing a method for manufacturing a capacitor according to the present invention.

FIGS. 9(f₁) to 9(f₂) are manufacturing process views schematically showing a method for manufacturing a capacitor according to the present invention.

FIGS. 10(g) to 10(h) are manufacturing process views schematically showing a method for manufacturing a capacitor according to the present invention.

FIGS. 11(i) to 11(k) are manufacturing process views schematically showing a method for manufacturing a capacitor according to the present invention.

FIG. 12 is an enlarged sectional view of a main part of a second embodiment of a capacitor according to the present invention.

FIG. 13 is a schematic cross-sectional view of a third embodiment of a capacitor according to the present invention.

FIG. 14 is a schematic cross-sectional view of a fourth embodiment of a capacitor according to the present invention.

FIG. 15 is a schematic cross-sectional view of a fifth embodiment of a capacitor according to the present invention.

FIG. 16 is a schematic cross-sectional view of a sixth embodiment of a capacitor according to the present invention.

FIG. 17 is a schematic cross-sectional view of a seventh embodiment of a capacitor according to the present invention.

### DETAILED DESCRIPTION OF THE INVENTION

Next, an embodiment of the present invention will be described in detail.

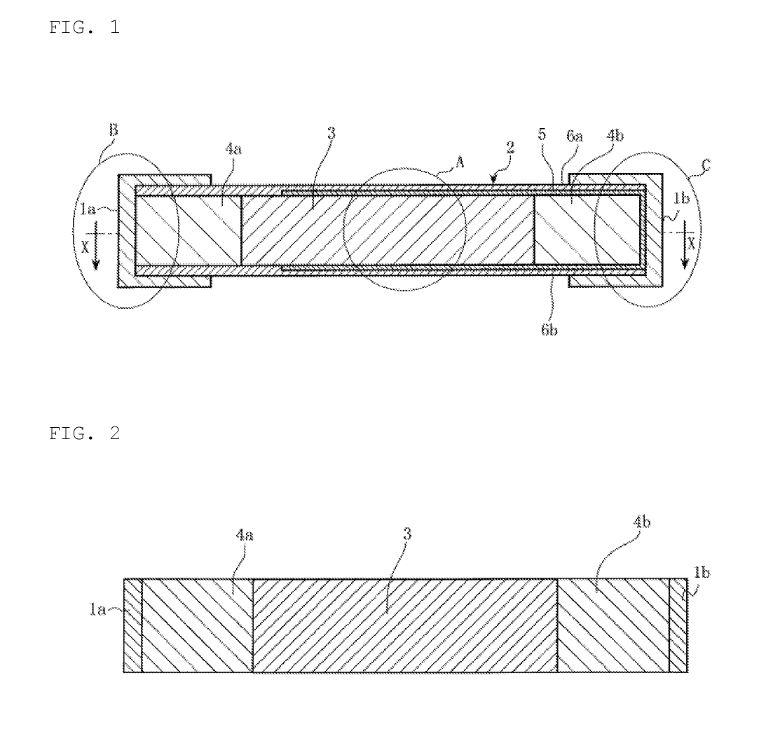

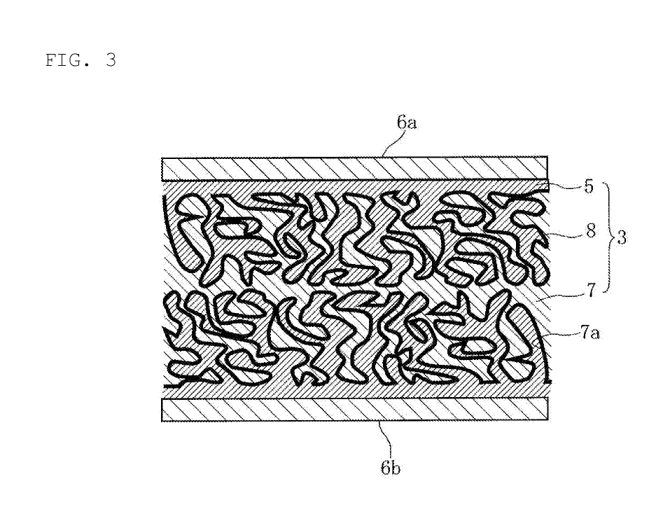

FIG. 1 is a schematic cross-sectional view of an embodiment (first embodiment) of a capacitor according to the present invention, and FIG. 2 is a sectional view viewed from the arrow direction of the X-X line of FIG. 1.

In the capacitor, two terminal electrodes (a first terminal electrode 1a and a second terminal electrode 1b) electrically insulated from each other are formed at both ends of an element main body 2.

The element main body 2 is comparted into a first region 3 that principally contributes to the acquisition of the capacitance and second regions 4a, 4b formed at both ends of the first region 3, and a conductive part 5 is formed on the first region 3 and the second region 4b.

Further, protective layers 6a and 6b made of an insulating material are formed on both principal surfaces of the element main body 2.

FIG. 3 is an enlarged sectional view showing a detail of an A part of FIG. 1.

That is, the first region 3 has a high specific surface area substrate 7 made of an electrical conductive material which has fine pores 7a formed therein and has a large specific surface area, a dielectric layer 8 which is formed on the surface of the high specific surface area substrate 7, and the above-mentioned conductive part 5.

The dielectric layer 8 is formed in a prescribed region of the surface including the inner surfaces of the pores 7a, and deposited in increments of an atomic layer. Thereby, the dielectric layer 8 is formed as a dense film, and therefore defects are few and insulating properties are high in contrast to the case of a solid electrolytic capacitor in which the dielectric layer is formed through anodizing. Further, since a polarity is not imparted to a capacitor, a capacitor having good usability can be attained.

The conductive part 5 is formed on the dielectric layer 8 so as to cover and fill the pores 7a with the material that forms the conductive part 5. Further, the conductive part 5 is formed along both of upper and lower principal surfaces of the high specific surface area substrate 7.

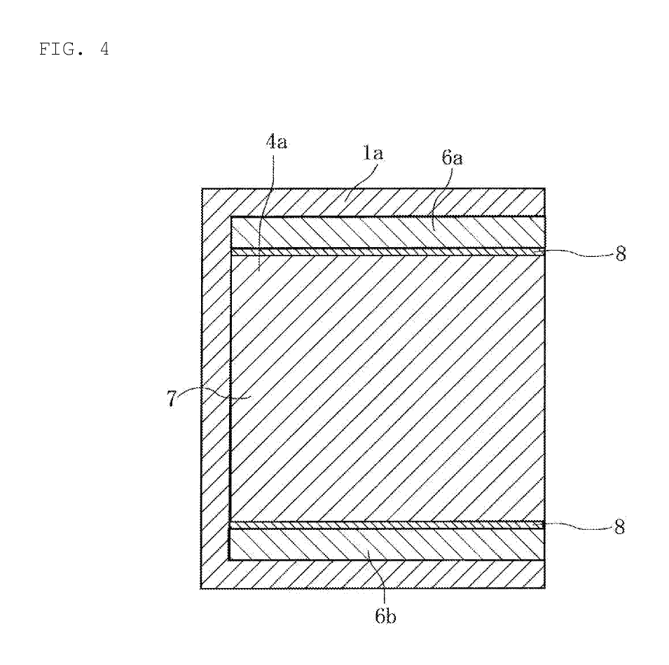

FIG. 4 is an enlarged sectional view showing a detail of a B part of FIG. 1.

In the second region 4a, the dielectric layer 8 is formed on the surface of the high specific surface area substrate 7 excluding an end surface of the substrate 7, the high specific surface area substrate 7 and the dielectric layer 8 are exposed to the surface at the end surface, and the first terminal electrode 1a and the high specific surface area substrate 7 are electrically connected to each other.

In addition, in FIG. 4, as described above, the dielectric layer 8 is formed on the surface of the high specific surface area substrate 7 excluding an end surface of the substrate 7, that is, a whole area of side surface of the substrate 7, in the second region 4a, but the dielectric layer 8 does not always have to be formed on the whole area of the side surface of the second region 4a, and a part of the side surface of the high specific surface area substrate 7 does not have to be covered with the dielectric layer 8.

FIG. 5 is an enlarged sectional view showing a detail of a C part of FIG. 1.

In the second region 4b, the dielectric layer 8 is formed on the surface of the high specific surface area substrate 7, and the conductive part 5 is formed on the surface of the dielectric layer 8. Then, the conductive part 5 is electrically connected to the second terminal electrode 1b, and the second terminal electrode 1b and the high specific surface area substrate 7 are electrically insulated from each other with the dielectric layer 8 interposed therebetween.

As described above, the element main body 2 has the first region 3 formed integrally with the second regions 4a and 4b, the above-mentioned high specific surface area substrate 7 as a substrate, the dielectric layer 8 and the conductive part 5. Then, the first region 3 is a region that principally contributes to the acquisition of the capacitance, and therefore in the first region 3, the high specific surface area substrate 7 is formed so as to increase the void ratio. On the other hand, the second regions 4a and 4b are each a region that contributes to the securement of the mechanical strength, and therefore the second regions 4a and 4b are formed so as to have a smaller void ratio than the first region 3.

That is, the void ratio of the high specific surface area substrate 7 is not particularly limited; however, the void ratio is preferably 30 to 80%, and more preferably 35 to 65% in consideration of mechanical strength since the first region 3 is, as described above, a region that principally contributes to the acquisition of the capacitance. Further, since the second regions 4a and 4b are each a region that contributes to the securement of the mechanical strength, the void ratio of the second regions are preferably 25% or less, more preferably 10% or less, and may be 0% at which the void does not exist.

In addition, a method of manufacturing the high specific surface area substrate 7 is not particularly limited, and for example, the high specific surface area substrate 7 can be manufactured by an etching method, a sintering method, a dealloying method or the like as described later, and a metallic etching foil, a sintered body, a porous metal body or the like respectively manufactured by these methods can be used as the high specific surface area substrate 7.

The second regions 4a and 4b can be formed by subjecting the high specific surface area substrate 7 to press working or laser irradiation, for example, to cause the destruction of the pores 7a. A regional ratio between the first region 3 and the second regions 4a and 4b in the high specific surface area substrate 7 is set according to a capacitance to be acquired. For example, the regional ratio of the first region 3 is increased in the case of preparing a capacitor having a high capacity, and on the other hand, the regional ratio of the second regions 4a and 4b is increased in the case of securing the mechanical strength but reducing the capacitance.

A thickness of the high specific surface area substrate 7 is not particularly limited; however, the thickness is preferably 10 to 1000 μm, and more preferably 30 to 300 μm from the viewpoint of achieving desired miniaturization while securing the mechanical strength.

In addition, in the present embodiment, by improving the mechanical strength, a ratio of a length L to a height H of the element main body 2 can be set to 3 or more, preferably 4 or more, and therefore a capacitor which is low in height and is small and high capacity can be obtained.

A material of such a high specific surface area substrate 7 is not particularly limited as long as the material has a conductive property, and for example, metal materials such as Al, Ta, Ni, Cu, Ti, Nb and Fe, or alloy materials such as stainless steel and duralumin can be used.

However, the high specific surface area substrate 7 is preferably formed of a highly conductive material, particularly a metal material having specific resistance of 10 6μΩ·cm or less, from the viewpoint of more effectively reducing the ESR, and a semiconductor material such as Si is not preferred.

A material for forming the dielectric layer 8 is not particularly limited as long as the material has insulating properties, and it is possible to use, for example, AlOₓ such as Al₂O₃; SiOₓ such as SiO₂; metal oxides such as AlTiOₓ, SiTiOₓ, HfOₓ, TaOₓ, ZrOₓ, HfSiOₓ, ZrSiOₓ, TiZrOₓ, TiZrWOₓ, TiOₓ, SrTiOₓ, PbTiOₓ, BaTiOₓ, BaSrTiOₓ, BaCaTiOₓ and SiAlOₓ; metal nitrides such as AlNₓ, SiNₓ and AlScNx; and metal oxynitrides such as AlOₓN_{y}, SiOₓN_{y}, HfSiOₓN_{y} and SiCₓO_{y}N_{z}. Further, the dielectric layer 8 does not need to have crystallinity from the viewpoint of forming a dense film, and an amorphous film is preferably used.

A thickness of the dielectric layer 8 is not particularly limited; however, the thickness is preferably 3 to 100 nm, and more preferably 10 to 50 nm from the viewpoint of enhancing insulating properties to inhibit a leakage current and securing a large capacitance.

The variation of the film thickness of the dielectric layer 8 is not particularly limited; however, the film thickness preferably has uniformity from the viewpoint of acquiring a stable and desired capacitance. In the present embodiment, the variation of the film thickness can be 10% or less on an absolute value basis with reference to an average film thickness by using an atomic layer deposition method described later.

A material for forming the conductive part 5 is not particularly limited as long as it has a conductive property, and Ni, Cu, AI, W, Ti, Ag, Au, Pt, Zn, Sn, Pb, Fe, Cr, Mo, Ru, Pd and Ta, and alloys thereof (for example, CuNi, AuNi and AuSn); metal nitrides such as TiN, TiAlN and TaN; metal oxynitrides such as TiON and TiAlON; and conductive polymers such as PEDOT/PSS (poly(3,4-ethylenedioxythiophene)/polystyrene sulfonic acid), polyaniline and polypyrrole, for example, can be used, and metal nitrides and metal oxynitrides are preferred in consideration of a filling property in the pores 7a or film-forming properties. In addition, when such a metal nitride or metal oxide nitride, or a conductive polymer is used, it is preferred to form a metal film such as a Cu film or a Ni film on the surface of the conductive part 5 by a plating method or the like in order to further reduce electric resistance.

A thickness of the conductive part 5 is also not particularly limited; however, it is preferably 3 nm or more, and more preferably 10 nm or more for obtaining a conductive part 5 having lower resistance.

A material for forming the protective layers 6a and 6b is also not particularly limited as long as the material has insulating properties, and the same material as in the dielectric layer 8, for example, SiNₓ, SiOₓ, AlTiOₓ and AlOₓ, can be used; however, SiOₓ is preferably used, and resin materials such as an epoxy resin and a polyimide resin, and a glass material, for example, can also be used.

A thickness of the protective layers 6a and 6b is not particularly limited as long as the thickness can ensure moisture resistance and insulating properties, for example, and the protective layers can be formed, for example, in a thickness of about 0.3 μm to 50 μm, preferably about 1 μm to 20 μm.

Forming materials and thicknesses of the first and the second terminal electrodes 1a and 1b are also not particularly limited as long as they provide a desired conductive property, and for example, metal materials such as Cu, Ni, Sn, Au, Ag, and Pb, or alloys thereof can be used. The thickness to be formed is 0.5 μm to 50 μm, and preferably 1 μm to 20 μm.

As described above, in the present embodiment, a small and highly reliability capacitor with a high capacity which has low resistance and good insulating properties, and hence has small ESR and a high dielectric breakdown voltage can be obtained.

In the present capacitor, since the high specific surface area substrate 7 has the second regions 4a and 4b having a low void ratio and high mechanical strength, it is possible to improve the durability against stress, particularly, flexure stress, added in mounting on a substrate such as a glass epoxy substrate, a ceramic substrate or a resin substrate.

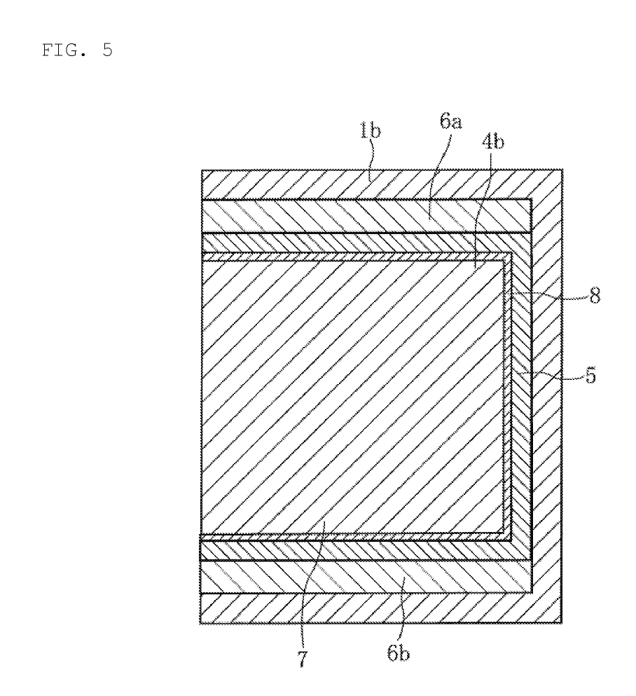

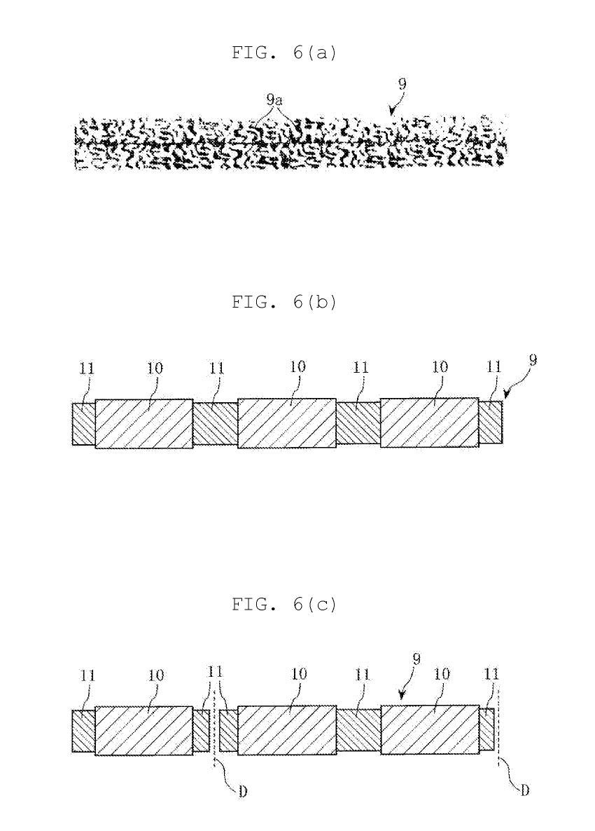

Next, a method for manufacturing the above-mentioned capacitor will be described in detail based on FIG. 6(a) to FIG. 11(k).

First, as shown in FIG. 6(a), is prepared an aggregate substrate 9 made of an electrical conductive material which has fine pores 9a formed therein and has a large specific surface area.

As the aggregate substrate 9, as described above, the metallic etching foil, the metal sintered body, the porous metal body or the like can be used.

The metallic etching foil can be produced by passing a predetermined current in an optional direction through a metal foil such as an Al foil and etching the metal foil. The metal sintered body can be produced by forming a metal powder such as Ta and Ni in the form of a sheet, heating the resulting metal sheet at a temperature lower than a melting point of the metal, and firing the sheet. The porous metal body can be produced by using the dealloying method. That is, only a less noble metal is dissolved in an electrolytic solution such as an acid and removed from a binary alloy of an electrochemically noble metal and an electrochemically less noble metal. The nobler metal remaining undissolved in dissolving/removing the less noble metal forms open pores of the order of nanometer, and thereby a porous metal body can be produced. In this way, a produced aggregate substrate 9 is prepared.

Next, as shown in FIG. 6(b), the aggregate substrate 9 is subjected to a comparting treatment to compart the aggregate substrate 9 into a first region site 10 serving as the above-mentioned first region 3 and a second region site 11 serving as a second region 4a or 4b.

A method of the comparting treatment is not particularly limited, and the above-mentioned sites can be formed by causing the destruction of the pores 9a of the aggregate substrate 9 using press working, laser irradiation or the like.

For example, when the comparting treatment is performed using press working, a die having a prescribed width dimension is used, a pressure is applied to the aggregate substrate 9 from both of an upper side and a lower side, or one principal surface of the aggregate substrate 9 is fixed to a pedestal or the like, and a pressure is applied to the other principal surface using a die or the like, and thereby, the second region site 11 can be formed. In this case, by adjusting the width dimension of the die or the like, the regional ratio between the first region site 10 and the second region site 11 can be adjusted, and the capacitance of a capacitor can be adjusted as described above.

When the comparting treatment is performed using laser irradiation, a predetermined location of the aggregate substrate 9 is irradiated with a YVO₄ laser, a CO₂ laser, a YAG laser, an excimer laser, a fiber laser, or a full solid state pulsed laser such as a femtosecond laser, a picosecond laser, or a nanosecond laser to cause the destruction of the pores 9a, and thereby the second region site 11 can be formed. In addition, when the second region site 11 is formed by such laser irradiation, the above-mentioned full solid state pulsed laser is preferably used in order to control a shape or a void ratio of the second region site 11 with higher precision.

The comparting treatment can be performed by a method other than the press working or the laser irradiation. For example, the pores 9a of the aggregate substrate 9 may be filled by an appropriate method to cause the destruction of the pores 9a, and thereby, the second region site 11 is obtained. Further, when the aggregate substrate 9 is formed of the metallic etching foil, a location on which the second region site 11 is to be formed is masked with a masking material and etched, the etched location is designated as a first region site 10 and a non-etched location is designated as a second region site 11, and thereby, the comparting treatment can be performed.

Next, as shown in FIG. 6(c), the aggregate substrate 9 is cut along a broken line D. That is, the second region site 11 is cut at its central part or its roughly central part so as to form a set of two first region sites 10 between which the second region site 11 is sandwiched.

Here, a method of cutting the aggregate substrate 9 is not particularly limited, and the aggregate substrate 9 can be easily cut, for example, by cutting by laser irradiation, die cutting, or use of a cutting tool such as a dicer, a cemented carbide blade, a slitter and a pinnacle blade.

In addition, the occurrence of burrs or shear drop can be suppressed by thus cutting the aggregate substrate 9 at the second region site 11 with a small void ratio. That is, when the aggregate substrate 9 which has fine pores 9a formed therein and has a large specific surface area is cut, there is a possibility that burrs are generated or shear drop occurs resulting from extension/deformation, for example, in a cutting direction of a cutting surface. However, the occurrence of burrs or shear drop can be suppressed by cutting the aggregate substrate 9 at the second region site 11 with a small void ratio like the present embodiment.

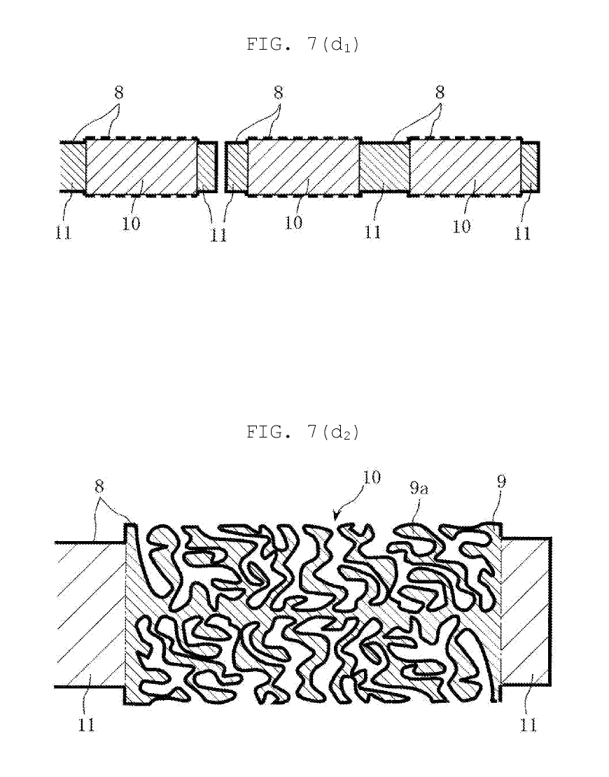

Next, as shown in FIG. 7(d₁), the dielectric layer 8 is formed on the surface of the aggregate substrate 9. FIG. 7(d₂) is an enlarged sectional view of a main part of FIG. 7(d₁). The dielectric layer 8 is specifically formed in a prescribed region of the surface of the aggregate substrate 9 including the inner surfaces of the pores 9a, as shown in FIG. 7(d₂).

A method of forming the dielectric layer 8 is not particularly limited, and the dielectric layer 8 can be manufactured by a chemical vapor deposition (hereinafter, referred to as “CVD”) method, a physical vapor deposition (hereinafter, referred to as “PVD”) method or the like; however, the dielectric layer 8 is preferably formed by an atomic layer deposition (hereinafter, referred to as “ALD”) method from the viewpoint of obtaining a dielectric layer 8 which is thin and dense and has a low leakage current and high insulating properties.

That is, in the CVD method, it is difficult to form a dielectric layer 8 having a uniform film thickness up to a deep inner surface of the fine pores 9a of the order of a nano since an organic metal compound as a precursor and a reaction gas such as water are simultaneously supplied to a reaction chamber and reacted to form a film. Further, the same is true on the PVD method in which a solid material is used.

In contrast, in the ALD method, an organic metal precursor is supplied to a reaction chamber to be chemically adsorbed, then the organic metal precursor excessively existing in a vapor phase is purged and removed, and then the adsorbed organic metal precursor is reacted with a reaction gas such as water vapor in the reaction chamber, and thereby, a thin film can be deposited in increments of an atomic layer in a prescribed region of the surface of the aggregate substrate 9 including the inner surfaces of the pores 9a. Accordingly, by repeating the above-mentioned process, thin films are laminated in increments of an atomic layer, and consequently a dense dielectric layer 8 of high quality having a uniform prescribed film thickness can be formed up to a deep inner surface of the pores 9a.

As described above, when the dielectric layer 8 is produced by the ALD method, it is possible to obtain a dielectric layer 8 which is thin and dense and has a low leakage current and high insulating properties, and to obtain a high capacity capacitor which has a stable capacity and good reliability.

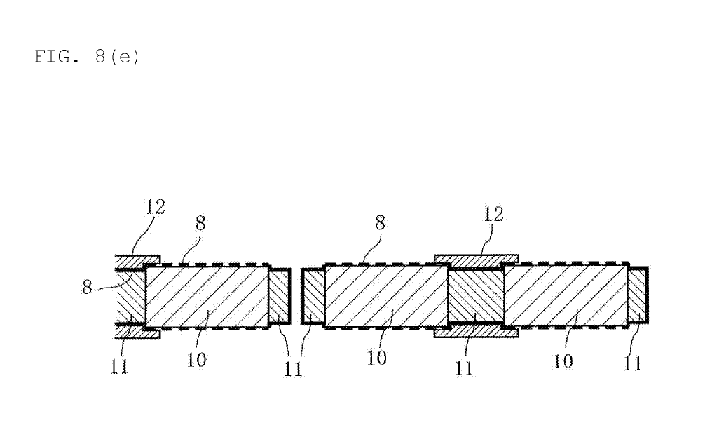

Next, as shown in FIG. 8(e), for the second region site 11 at which the terminal electrode should be formed, a flange-like mask part 12 is formed on the aggregate substrate 9 so as to cover the second region site 11.

In addition, a material and a method for forming the mask part 12 are not particularly limited, and for example, as a forming material, an epoxy resin, a polyimide resin, a silicone resin, a fluororesin or the like can be used, and as a forming method, an optional method, such as a printing method, a dispenser method, a dip method, an ink-jet method, a spraying method and a photolithography method, can be used.

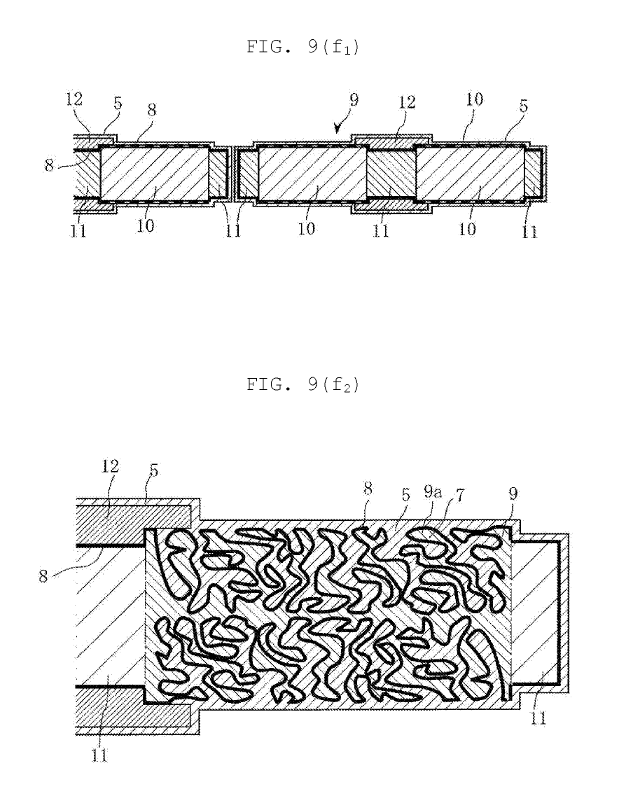

Next, as shown in FIG. 9(f₁), the conductive part 5 is formed on the surface of the dielectric layer 8. FIG. 9(f₂) is an enlarged sectional view of a main part of FIG. 9(f₁). The conductive part 5 is specifically filled in the inside of the pores 9a on which a dielectric layer 8 is formed and formed in a prescribed region of the surface of the aggregate substrate 9 including the inner surfaces of the pores 9a, as shown in FIG. 9(f₂).

A method of forming the conductive part 5 is also not particularly limited, and for example, a CVD method, a plating method, a bias sputtering method, a sol-gel method, a conductive polymer filling method or the like can be used; however, in order to attain a conductive part 5 which is dense and highly precise, an ALD method which is excellent in film-forming properties is preferably used as with the dielectric layer 8. Further, for example, a conductive layer is produced, by the ALD method, on the surface of the dielectric layer 8 formed inside the pores 9a, and an electrical conductive material may be filled in the pores 9a having the conductive layer produced thereon by a CVD method, a plating method or the like to thereby form a conductive part 5.

Next, using the same cutting method as in FIGS. 6(a) to 6(c) described above, the aggregate substrate 9 is cut along a broken line E to separate the aggregate substrate 9 into segments as element main body units as shown in FIG. 10(g), and thereby, an element main body 2 including the high specific surface area substrate 7 is obtained. That is, the element main body 2 has, at a central portion, the first region 3 with a large void ratio which principally contributes to the acquisition of the capacitance, and the second regions 4a and 4b are formed so as to continue across the first region 3. Further, the high specific surface area substrate 7 is exposed to the surface at the end surface of the second region 4a, and the conductive part 5 is exposed to the surface at the end surface of the second region 4b.

Next, the element main body 2 is subjected to a washing treatment or a heat treatment to remove the mask part 12, as shown in FIG. 10(h).

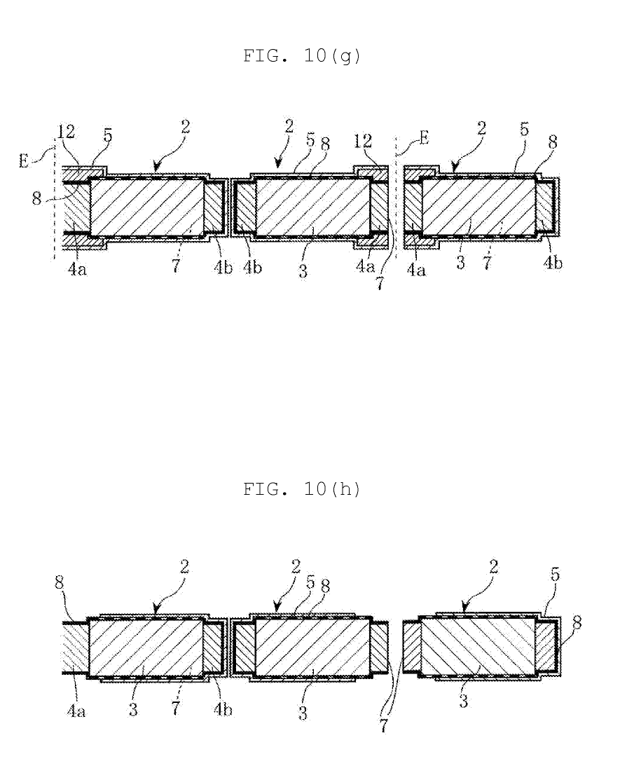

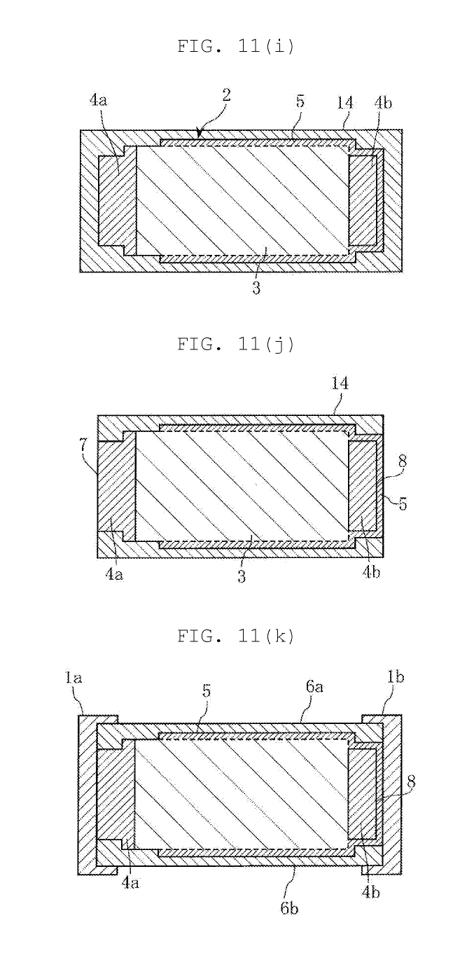

Next, as shown in FIG. 11(i), the element main body 2 is covered with an insulating material 14 using an appropriate method such as a CVD method, a plating method, a sputtering method, a spraying method or a printing method.

Next, as shown in FIG. 11(j), an insulating material 14 at both end surfaces of the insulating material 14 is eliminated by etching, protective layers 6a and 6b are formed as shown in FIG. 11(k), and thereby, the high specific surface area substrate 7 is exposed to the surface from one second region 4a, and the conductive part 5 is exposed to the surface from the other second region 4b.

Finally, a plating treatment or application/baking of a conductive paste is performed to form a first terminal electrode 1a and a second terminal electrode 1b at both ends of the element main body 2.

In addition, in the present embodiment, the element main body 2 is covered with an insulating material 14, and then etching is applied to sites at which the first and the second terminal electrodes 1a and 1b are formed, but patterning is performed with the insulating material 14 by a dispenser method or the like so as to expose, to the surface, the sites at which the first and the second terminal electrodes 1a and 1b are formed to form protective layers 6a and 6b, and thereafter, the first terminal electrode 1a and the second terminal electrode 1b may be formed.

As described above, according to the present manufacturing method, since the present manufacturing method includes the aggregate substrate preparation step of preparing an aggregate substrate 9 made of an electrical conductive material which has fine pores 9a formed therein and a large specific surface area; the dielectric layer formation step of forming a dielectric layer 8 in a prescribed region of the surface of the aggregate substrate 9 including the inner surfaces of the pores 9a; the conductive part formation step of forming a conductive part 5 on the surface of the aggregate substrate 9 so as to meet the dielectric layer 8; the segmenting step of separating the aggregate substrate 9 into segments to obtain the element main body 2 including the high specific surface area substrate 7; and the terminal electrode formation step of forming the first terminal electrode la so as to be electrically connected to the high specific surface area substrate 7, and forming the second terminal electrode so as to be electrically insulated from the high specific surface area substrate 7, it is possible to obtain, with high efficiency, capacitors from a large and aggregate substrate 9 by a so-called multi-piece method, the capacitor being small and high capacity, and has low resistance, good insulating properties and good reliability to ensure high productivity.

Further, since the second region site 11 has good mechanical strength, it is possible to inhibit the aggregate substrate 9 from deforming or the element main body 2 obtained by separating the aggregate substrate 9 into segments from deforming during a manufacturing process.

In the present capacitor, since the mechanical strength is secured by the second region site 11, it is possible to inhibit the occurrence of delamination, cracks, short circuit, and the like resulting from deformation of the element main body 2.

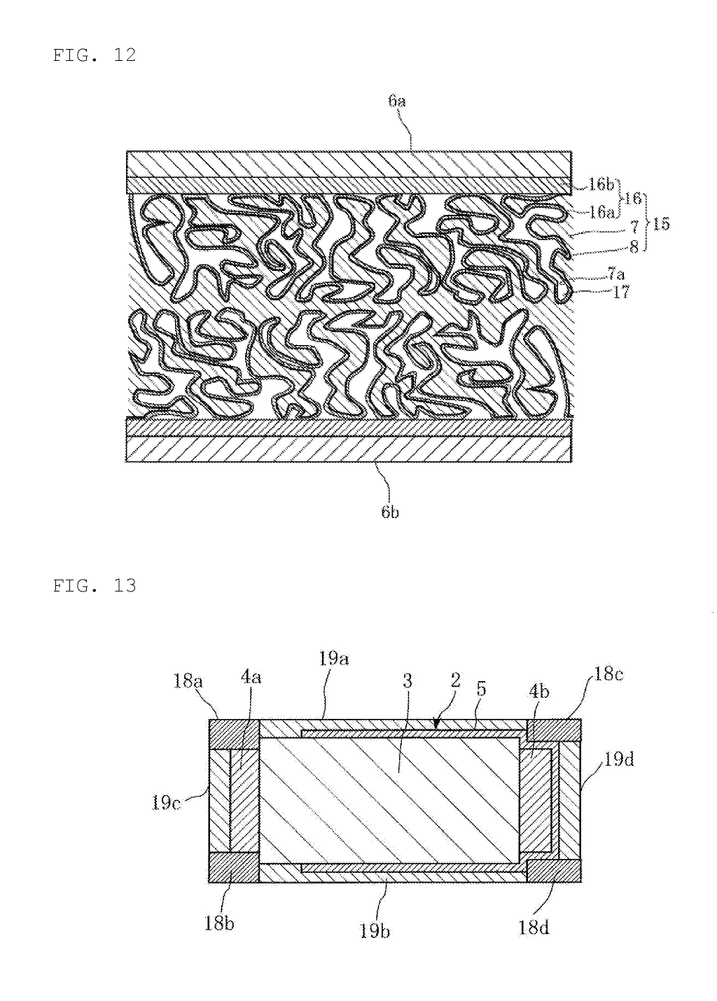

FIG. 12 is a schematic enlarged sectional view of a main part of a second embodiment of a capacitor according to the present invention, and shows a detail of a first region 15.

Also in the present second embodiment, as with the first embodiment, the first region 15 has a high specific surface area substrate 7 made of an electrical conductive material which has a large number of fine pores 7a formed therein, a dielectric layer 8 which is formed in a prescribed region of the surface including the inner surfaces of the pores 7a, and a conductive part 16.

Then, while in the first embodiment, the conductive part 5 is filled in the pores 7a, in the present second embodiment, a conductive part 16 has a main conductive part 16a which is formed in a prescribed region of the surface in a state of meeting the dielectric layer 8 so that a cavity 17 is formed at an inner surface of the pore 7a,and a sub conductive part 16b which is electrically connected to the main conductive part 16a and extended in a side surface direction.

As described above, the main conductive part 16a may be formed so that the cavity 17 is formed inside the pore 7a. In doing so, the main conductive part 16a is preferably formed by the ALD method which is suitable for forming a thin layer in the pores 7a as with the first embodiment, and the sub-conductive part 16b can be formed by the plating method or the sputtering method, for example.

Then, in doing so, with respect to the material for forming the conductive part 16, the main conductive part 16a preferably uses a metal nitride such as TiN or a metal oxynitride, or a metal material such as Ru, Ni, Cu or Pt which is suitable for the ALD method, and the sub-conductive part 16b preferably uses a metal material, such as Cu or Ni, in which lower resistance can be achieved and ESR can be reduced.

In addition, a part of or all the cavity 17 may be filled with a resin or a glass material, for example, after forming the main conductive part 16a.

The second embodiment can also be produced by the same method/procedure as in the first embodiment, and for example, a main conductive part 16a is produced, and then in the subsequent step, a sub-conductive part 16b can be produced. A metal film such as Cu can be formed on the sub-conductive part 16b as required to further reduce resistance.

FIG. 13 is a schematic cross-sectional view of a third embodiment of a capacitor according to the present invention, and in the present third embodiment, the first and the second terminal electrodes 18a to 18d are formed at four corner parts of the element main body 2.

That is, in the element main body 2, protective layers 19a and 19b are formed on the side surfaces of the first region 3, and protective layers 19c and 19d are formed on the end surfaces of the second regions 4a and 4b, respectively. Further, the dielectric layer is not formed on one second region 4a, and is formed on only the first region 3 that principally contributes to the acquisition of the capacitance and the other second region 4b. Then, the first terminal electrodes 18a and 18b are formed on an upper surface and a lower surface of the second region 4a of the element main body 2 and on an upper surface and a lower surface of the protective layer 19c, and these first terminal electrodes 18a and 18b are electrically connected to the high specific surface area substrate. Further, the second terminal electrodes 18c and 18d are formed on an upper surface and a lower surface of the second region 4b of the element main body 2 and on an upper surface and a lower surface of the protective layer 19d, and these second terminal electrodes 18c and 18d are electrically connected to the conductive part 5, and electrically insulated from the high specific surface area substrate with the dielectric layer interposed therebetween.

As described above, the first and the second terminal electrodes 18a to 18d have only to have a plurality of electrodes, and may be formed not on the end surface of the element main body 2 but on the surface of a corner part.

In the third embodiment, distances between the first and the second terminal electrodes 18a to 18d and the conductive part 5 can be shortened, and thereby, resistance can be further reduced and ESR can be further reduced.

The capacitor of the third embodiment can be easily manufactured in the following manner.

That is, many element main bodies 2 are acquired from a large aggregate substrate by nearly the same method/procedure as in the first embodiment described above. However, in this case, the dielectric layer is formed on only the first region 3 and the second region 4b of the high specific surface area substrate, and is not formed on the second region 4a. Then, for the element main body 2 thus formed, protective layers 19a to 19d are provided.

Here, the protective layers 19a to 19d can be produced by covering the entire element main body 2 with an insulating material to serve as a protective layer, removing a corner part by etching or masking a corner part with a masking material, covering a location exposed to the surface with an insulating material, and then eliminating the masking material.

Then, thereafter, the first and the second terminal electrodes 18a to 18d are produced using a plating method, an application/firing method or the like, and thereby, a capacitor of the present third embodiment can be obtained.

In addition, in the third embodiment, while the first region 3 meets the first terminal electrodes 18a and 18b, the first terminal electrodes 18a and 18b have only to meet the second region 4a, and may be formed so as not to meet the first region 3.

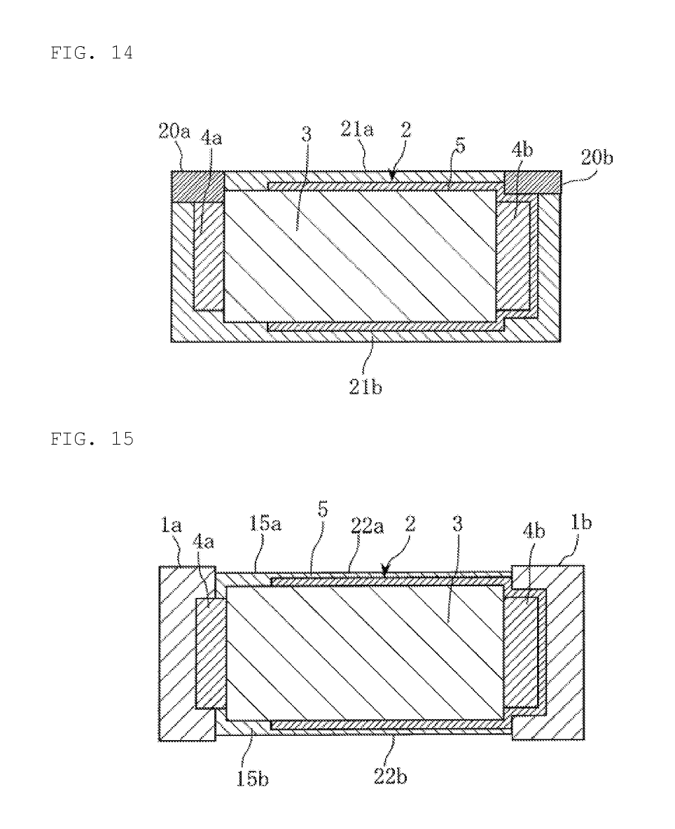

FIG. 14 is a schematic cross-sectional view of a fourth embodiment of a capacitor according to the present invention, and in the present fourth embodiment, the first and the second terminal electrodes 20a and 20b are formed at two corners of the element main body 2.

That is, the element main body 2 is covered with protective layers 21a and 21b excluding locations on which the first and the second terminal electrodes 20a and 20b are formed. Further, as with the third embodiment, the dielectric layer is not formed on one second region 4a, and is formed on only the first region 3 that contributes to the acquisition of the capacitance and the other second region 4b. Then, the first terminal electrode 20a is formed at the second region 4a of the element main body 2 and on an upper surface of one side of the protective layer 21b, and the first terminal electrode 20a is electrically connected to the high specific surface area substrate. Further, the second terminal electrode 20b is formed at the second region 4b of the element main body 2 and on an upper surface of the other side of the protective layer 21b, and the second terminal electrode 20b is electrically connected to the conductive part 5, and electrically insulated from the high specific surface area substrate with the dielectric layer interposed therebetween.

In the fourth embodiment, as with the third embodiment, distances between the first and the second terminal electrodes 20a and 20b and the conductive part 5 can be shortened, and thereby, resistance can be further reduced and ESR can be further reduced.

In the present fourth embodiment, since the first and the second terminal electrodes 20a and 20b are formed on and at the second regions 4a and 4b, mechanical strength of a periphery of the first and the second terminal electrodes 20a and 20b on which the stresses tend to concentrate is improved, and therefore the mechanical strength of an entire capacitor can be enhanced.

The capacitor of the fourth embodiment can be easily manufactured by nearly the same method as in the third embodiment.

That is, many element main bodies 2 are acquired from a large aggregate substrate by nearly the same method/procedure as in the third embodiment described above, and protective layers 21a and 21b are formed on each of the element main bodies 2.

Here, the protective layers 21a and 21b can be produced by nearly the same method as in the third embodiment. That is, the protective layers 21a and 21b can be produced by covering the entire element main body 2 with an insulating material to serve as a protective layer, removing an upper corner part by etching or masking an upper corner part with a masking material, covering a location exposed to the surface with an insulating material, and then eliminating the masking material.

Then, thereafter, the first and the second terminal electrodes 20a and 20b are produced using a plating method, an application/firing method or the like, and thereby, a capacitor of the present fourth embodiment can be obtained.

In addition, in the fourth embodiment, while the first region 3 meets the first terminal electrode 20a, as with the third embodiment, the first terminal electrode 20a has only to meet the second region 4a, and may be formed so as not to meet the first region 3.

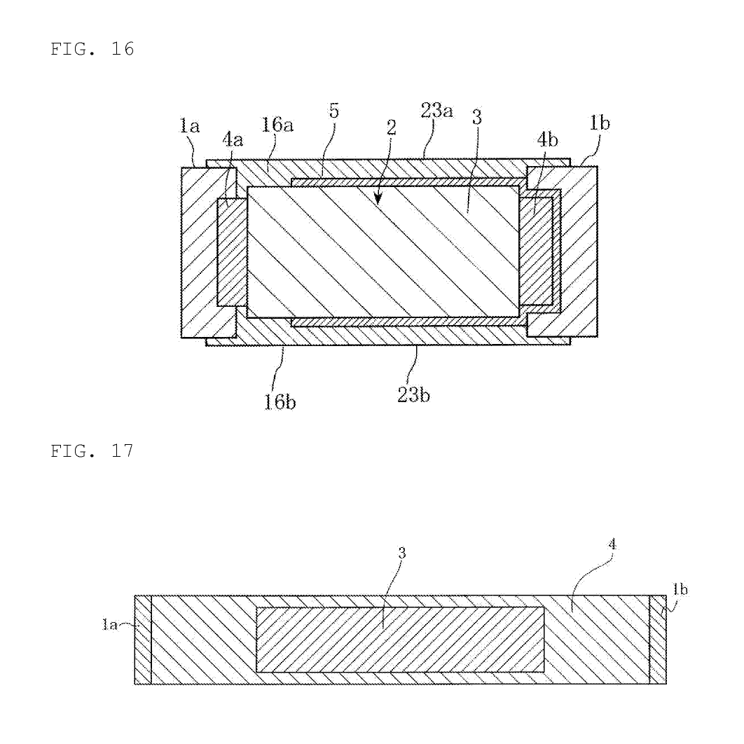

FIG. 15 is a schematic cross-sectional view of a fifth embodiment of a capacitor according to the present invention, and FIG. 16 is a schematic cross-sectional view of a sixth embodiment of a capacitor according to the present invention.

In the fifth embodiment, as shown in FIG. 15, protective layers 22a and 22b are formed in the form of a thin film. By making the protective layers 22a and 22b thin in this way so that these layers are lower than an overall height of the first and the second terminal electrodes 1a and 1b, it is possible to inhibit the inclination of a component at the time of being placed still which can occur due to the projections and depressions of the protective layers 22a and 22b.

Further, in the sixth embodiment, as shown in FIG. 16, protective layers 23a and 23b are formed in the form of a thick film. By making the protective layers 23a and 23b thick in this way so that these layers are higher than an overall height of the first and the second terminal electrodes 1a and 1b, it is possible to inhibit the migration resulting from a metal material constituting the first and the second terminal electrodes 1a and 1b.

FIG. 17 is a schematic cross-sectional view of a seventh embodiment of a capacitor according to the present invention, and shows another embodiment of the sectional view viewed from the arrow direction of the X-X line of FIG. 1.

That is, in the first embodiment, the second regions 4a and 4b respectively having a small void ratio are formed at both ends of the first region 3 having a large void ratio, but the second regions 4a and 4b may be formed at at least both ends of the element main body 2, and the second region 4 may be formed so as to surround the first region 3 like this seventh embodiment.

In this seventh embodiment, it is preferred from the viewpoint of placing emphasis on the securement of the mechanical strength to form a capacitor so that the first region 3 is surrounded with the second region 4 like this seventh embodiment although the capacitance slightly tends to decrease since the first region 3 is narrowed.

As described above, in the present invention, it is preferred to appropriately change a shape or the like according to uses or required performance/quality, and thereby, it becomes possible to attain a capacitor which is small and high capacity and has a wide application range.

Furthermore, the present invention is not limited to the above-mentioned embodiments, and various variations may be further made.

For example, the dielectric layer 8 may be formed in a prescribed region of the surface including the pores 7a of the high specific surface area substrate 7, and an intermediate layer may be interposed between the dielectric layer 8 and the high specific surface area substrate 7 in order to improve adhesion.

Further, a manufacturing procedure described in the above embodiments is an example, the order of the above-mentioned manufacturing steps can be appropriately changed as long as the steps are included. In the above embodiments, the comparting treatment to compart the aggregate substrate 9 into the first region site 10 and the second region site 11 is performed before the formation of the dielectric layer 8, but the comparting treatment may be performed after the formation of the dielectric layer 8. Further, for example, in the above embodiments, the mask part 12 is formed before the formation of the dielectric layer 8, but the dielectric layer 8 may be formed before the formation of the mask part 12.

Next, examples of the present invention will be specifically described.

### EXAMPLE 1

(Production of Specimen)

As an aggregate substrate, an etched Al foil of 50 mm long, 50 mm wide and 110 μm thick was prepared.

Then, preparing a die having a width of 200 μm, press working was applied to the Al foil at intervals of 1.0 mm long and 0.5 mm wide to cause the destruction of pores, and thereby, the Al foil was comparted into a first region site and a second region site. In addition, in this comparting treatment, the Al foil was cut for every prescribed width of the element main body.

Then, the Al foil was cut by laser irradiation so as to form a set of two first region sites between which the second region site is sandwiched (refer to FIGS. 6(a) to 6(c)).

Next, a dielectric layer made of Al₂O₃ was formed in a prescribed region of the surface including inner surfaces of pores of the Al foil by using an ALD method for the Al foil. Specifically, trimethyl aluminum (Al(CH₃)₃) (hereinafter, referred to as “TMA”) gas was used as an organic metal precursor, and TMA was supplied to a reaction chamber in which the Al foil was placed still to adsorb the TMA on the Al foil. Then, after the TMA gas excessively existing in a vapor phase was purged, water vapor (H₂O) was supplied to the reaction chamber to react the TMA with H₂O, and thereby a thin film made of Al₂O₃ was formed. This treatment was repeated plural times so that a film thickness becomes 15 nm to form a dielectric layer made of Al₂O₃ in a prescribed region of the surface including inner surfaces of pores of the Al foil (refer to FIGS. 7(dᵢ) to 7(d₂)).

Next, screen printing was performed using a polyimide resin to form a mask part on a location on which the first terminal electrode is to be formed (refer to FIG. 8(e)).

Then, a conductive part made of TiN was produced on the dielectric layer. Specifically, a titanium tetrachloride (TiCl₄) gas was used as an organic metal precursor, and the titanium tetrachloride gas was supplied onto the Al foil having the dielectric layer formed thereon to adsorb titanium tetrachloride on the dielectric layer. Then, after the TiCl₄ gas excessively existing in a vapor phase was purged, an ammonia (NH₃) gas was supplied to the reaction chamber to react the TiCl₄ gas with the NH₃ gas, and thereby a thin film made of TiN was formed. This process was repeated plural times so as to have a film thickness of 10 nm to form a conductive part made of TiN on the dielectric layer (refer to FIGS. 9(f₁) to 9(f₂)).

Thereafter, this was immersed in an electroless Cu-plating bath to form a Cu film having a thickness of 10 μm on the conductive part.

Next, a roughly central part of the mask part was cut by laser irradiation, and then the mask part was removed by heat treatment at a temperature of 400° C. to 500° C. to thereby obtain an element main body (refer to FIGS. 10(g) to 10(h)).

Next, using a CVD method, the element main body was covered with an insulating material made of SiO₂ so as to have a thickness of about 1 μm. Then, both end surfaces of the element main body were etched using a fluorine gas to remove the insulating material on the both end surfaces of the element main body, and thereby, protective layers were formed.

Then, using a plating method, a Ni layer having a thickness of 5 μm and a Sn layer having a thickness of 3 μm were formed in turn at both ends of the element main body, and thereby, a first terminal electrode and a second terminal electrode were produced to obtain specimens for examples from one sheet of Al foil (refer to FIGS. 11(i) to 11(k)).

(Evaluation of Specimen)

Two specimens were optionally extracted from the specimens, the void ratios of the first region and the second region were measured by the following method.

First, using an FIB (focused ion beam) apparatus (manufactured by Seiko Instrument Inc., SMI 3050SE), a roughly central part of the etching foil was processed by a FIB pick-up method to be made a thin piece so that a thickness is about 50 nm, and thereby, a measuring specimen was produced. In addition, a FIB-damaged layer produced in making the etching foil a thin piece was removed using an Ar ion milling apparatus (manufactured by GATAN, Inc., PIPS model 691).

Next, using a scanning transmission electron microscope (JEM-2200FS manufactured by JEOL Ltd.), a region of 3 μm long and 3 μm wide was selected as an imaging region, and five optional locations were imaged. Then, the resulting images were analyzed, an area of an Al existing region (hereinafter, referred to as “existing area”) a1 was determined, and a void ratio x of each location was calculated based on a formula (1) from the existing area a1 and a measurement area a2 (=3 μm×3 μm).

x={(a2−a1)/a2}×100 (1)

That is, an average value of void ratios x of five locations was calculated for each of two specimens, an average value of the calculated average void ratios of two specimens was determined, and the average value was taken as a void ratio of the specimen. As a result of measurement, the void ratio of the first region was 55% and the void ratio of the second region was 11%.

Next, using an impedance analyzer (manufactured by Agilent Technologies, Inc., E4990A), the capacitances of twenty specimens optionally extracted were measured under the conditions of a voltage of 1 Vrms and a measuring frequency of 1 kHz at a temperature of 25° C.±2° C.

As a result of this, an average of twenty specimens was 0.55 μF.

Subsequently, using the impedance analyzer, the ESRs of the specimens were measured under the conditions of a voltage of 10 mV and a measuring frequency of 1 MHz at a temperature of 25° C.±2° C. As a result of this, an average of twenty specimens was 20 mΩ.

Further, a DC voltage applied between terminals of the capacitor was gradually increased, and a voltage at the time when a current passing through the specimen exceeded 1 mA was considered as a dielectric breakdown voltage. An average value of the dielectric breakdown voltages of the twenty specimens was 10.7 V.

A thickness of the dielectric layer of each of the specimens was evaluated in the following manner. That is, as with the above, using the FIB apparatus, a surface portion and a roughly central portion of the specimen were made thin pieces, a region of 3 μm long and 3 μm wide of each piece was imaged with the scanning transmission electron microscope, and dielectric layer thicknesses of the surface portion and the roughly central portion were measured at five locations. As a result of this, an average value of the film thickness of the dielectric layer was 15 nm, and the variation of the film thickness was 10% or less on an absolute value basis at a surface portion and roughly central portion, and it was confirmed that a dielectric layer having good uniformity of a film thickness was formed.

### EXAMPLE 2

Twenty specimens were produced by the same method/procedure as in the first embodiment except that a width of a die was set to 400 μm and a second region site was produced.

The capacitances of the specimens were measured as with Example 1, and consequently an average of the capacitances was 0.40 μF, and therefore it was confirmed that the capacitance can be controlled by adjusting a ratio between the first region and the second region.

The present invention realizes a new type of capacitor having low resistance and good insulating properties which is small and high capacity, has high reliability, and replaces conventional capacitors such as a solid electrolytic capacitor.

### DESCRIPTION OF REFERENCE SYMBOLS

1a, 18a, 18b, 20a: First terminal electrode (one terminal electrode)
1b, 18c, 18d, 20b: Second terminal electrode (the other terminal electrode)
2: Element main body
3: First region
4: Second region
4a, 4b: Second region
5: Conductive part
6a, 6b, 19a-19d, 21a, 21b, 22a, 23b: Protective layer
7a: Pore
7: High specific surface area substrate
8: Dielectric layer
9: Aggregate substrate
9a: Pore
10: First region site (first region)
11: Second region site (second region)

1. A capacitor comprising:
an element main body made of an electrical conductive material and having a plurality of pores formed therein;
a dielectric layer in a prescribed region of a surface of the element main body including inner surfaces of the plurality of pores;
a conductive part on the dielectric layer;
a first terminal electrode electrically connected to the element main body; and
a second terminal electrode electrically connected to the conductive part and electrically insulated from the first terminal electrode,
wherein the dielectric layer is interposed between the conductive part and the high specific surface area substrate, and the element main body and the second terminal electrode are electrically insulated from each other.

2. The capacitor according to claim 1, wherein the dielectric layer is formed by being deposited in increments of an atomic layer.

3. The capacitor according to claim 1 or 2, wherein the conductive part extends into the plurality of pores.

4. The capacitor according to claim 1, wherein the conductive part extends along the dielectric layer inside the pores.

5. The capacitor according to claim 1, wherein the electrical conductive material is a metal material.

6. The capacitor according to claim 1, wherein the conductive part is any one of a metal material and a conductive compound.

7. The capacitor according to claim 6, wherein the conductive compound contains a metal nitride or a metal oxide nitride.

8. The capacitor according to claim 1, wherein a variation of a film thickness of the dielectric layer is 10% or less on an absolute value basis with reference to an average film thickness thereof.

9. The capacitor according to claim 1, further comprising a protective layer made of an insulating material covering at least side surface parts of the element main body.

10. The capacitor according to claim 9, further comprising a metal film interposed between the protective layer and the conductive part.

11. The capacitor according to claim 1, wherein the first terminal electrode and the second terminal electrode are located at respective ends of the element main body so as to be opposed to each other.

12. The capacitor according to claim 1,
wherein the element main body has a first region that principally contributes to the acquisition of a capacitance and two second regions each having a smaller void ratio than the first region, and
the two second regions are provided at respective opposed ends of the first region.

13. A method for manufacturing a capacitor, the method comprising:
preparing an aggregate substrate made of an electrical conductive material which has a plurality of pores formed therein;
forming a dielectric layer in a prescribed region of a surface of the aggregate substrate including inner surfaces of the plurality of pores;
forming a conductive part on the dielectric layer;
separating the aggregate substrate into segments to obtain an element main body;
forming a first terminal electrode so as to be electrically connected to the element main body; and
forming a second terminal electrode so as to be electrically insulated from the element main body.

14. The method for manufacturing a capacitor according to claim 13, further comprising comparting the aggregate substrate into a plurality of regions,
wherein the plurality of regions includes a first region that principally contributes to the acquisition of a capacitance and a second region having a smaller void ratio than the first region.

15. The method for manufacturing a capacitor according to claim 14, wherein the second region is produced by causing the destruction of a part of the plurality of pores of the aggregate substrate.

16. The method for manufacturing a capacitor according to claim 14, wherein the comparting step includes a pressing or laser irradiation treatment.

17. The method for manufacturing a capacitor according to claim 13, wherein during the segmenting, the aggregate substrate is cut with use of any one of laser irradiation and a cutting tool.

18. The method for manufacturing a capacitor according to claim 13, wherein the dielectric layer is formed by an atomic layer deposition method.

19. The method for manufacturing a capacitor according to claim 13, wherein the conductive part is formed by an atomic layer deposition method.
